(19) United States
(12) Patent Application Publication
(10) Pub. No.: US 2010/0018811 A1
(43) Pub. Date: Jan. 28, 2010

(54) ELEVATORS

(76) Inventors: Davide Vaudo, Como (IT); Carlo Mezzadri, Milano (IT)

Correspondence Address: CARLSON GASKEY & OLDS, 400 W MAPLE STE 350, BIRMINGHAM, MI, 48009, US

(21) Appl. No.: 12/375,024

(22) PCT Filed: Jul. 24, 2006
(86) PCT No.: PCT/IB2006/002022

§ 371 Date: Jan. 26, 2009

(51) Int. Cl. B66B 7/02; B66B 7/04; B66B 11/00

(52) U.S. Cl. 187/409; 187/410; 414/814

(57) ABSTRACT

An elevator car assembly (10) comprises at least one runner (40) for engaging a wall (34) of a hoistway (30) such that the car assembly (10) may move within the hoistway (30) with the runner (40) in contact with the hoistway wall (30). The runner is preferably a wheel (40). The wheel (40) counteracts turning moments generated due to an offset between a suspension point of the car assembly (10) and its centre of gravity. Wheels (40) are preferably provided at a lower part of one side of the car assembly and at an upper part of an opposite side of the car assembly (10).

The present invention relates to elevators and in particular to the installation of elevators.

When installing elevator equipment such as guide rails in a hoistway, it is necessary to provide a platform within the hoistway for installation personnel to work on. Traditionally this has been done by erecting scaffolding within the hoistway. This is, however, costly and cumbersome, as not only must the scaffolding be erected in the first place, it must also be removed from the hoistway before the elevator car itself is installed.

It has therefore been proposed more recently to use the elevator car itself as an installation platform. Such an arrangement is described in WO 98/40305.

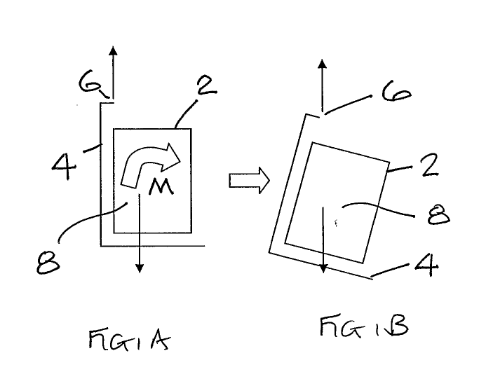

A particular problem arises in the installation of cantilever elevators. A cantilever elevator is one in which the guide rails of the elevator system are arranged to one side of the elevator car such that the elevator car projects from the guide rails in a cantilever manner. As shown in FIG. 1A, the elevator car 2 is typically mounted on a car frame 4 which is itself mounted to the guide rails in use. During installation, a hoist is attached to the car frame at a suspension location 6. However, the attachment location is offset from the centre of gravity 8 of the car 2. This creates a turning moment M as shown in FIG. 1A, which if not counteracted would lead to the car 2 rotating as shown in FIG. 1B.

Normally, this moment would counteracted by guide rollers provided on the car frame 4 reacting on the guide rails. This means, however, that in order for the car to be used as an installation platform, the guide rails must already be installed in the hoistway. This is disadvantageous since the car cannot then be used to assist in installing the guide rails themselves. The present invention therefore seeks to overcome or at least mitigate the above problem.

From a first aspect, therefore, the invention provides an elevator car assembly comprising at least one runner arranged to engage a wall of a hoistway such that the car assembly may move within the hoistway with the runner in contact with the hoistway wall.

Thus, in accordance with the invention, an elevator car assembly is provided with one or more runners which allow the car to move up and down in the hoistway, with the runners in engagement with the wall. This guides the car within the hoistway and counteracts any moment generated by offset suspension loads.

From a second aspect, therefore, the invention provides an elevator system comprising an elevator car assembly, the car assembly being suspended within a hoistway such that a turning moment is generated on the car assembly, said elevator car assembly further comprising at least one runner for engaging the hoistway wall so as to counter the turning moment.

In a simple embodiment of the invention, the at least one runner may be provided on just one side of the elevator car assembly. More particularly, the at least one runner may be provided at a lower part of the elevator car assembly on the same side of the elevator car assembly as the point or points of suspension of the car assembly. This is advantageous as the turning moment generated by the weight of the car assembly will tend to rotate the lower end of the car assembly towards the elevator wall such that the runner will engage the hoistway wall and thereby limiting rotation of the car within the hoistway.

An arrangement such as that described above may be suitable for hoistways which are relatively wide in the direction of the rotation of the car. However, with narrower hoistways, the rotation of the car due to the turning moment may bring the opposite, upper corner of the car assembly into contact with the opposite hoistway wall, thereby preventing movement of the car. In a further embodiment of the invention, one or more further runners may be provided at upper, opposite side of the car assembly for engagement with the opposite hoistway wall.

Of course, depending on the particular layout of the hoistway, it may be possible to provide one or more runners at just the upper location.

The runner may comprise a sliding element which may slide over the hoistway wall, but preferably the runner comprises a rolling element, for example, a roller or more preferably a wheel.

Preferably the roller or wheel has a resilient surface to better follow any discontinuities in the hoistway wall and to minimise vibrations and noise. For example, the wheel may be provided with a tyre, e.g. of rubber.

A single runner may be provided in a or each desired location, but preferably a plurality of runners is provided in each such location. Most preferably the runners are spaced apart across one or more sides of the car assembly so as to provide improved stability to the car assembly.

Preferably the car assembly comprises a car frame and car components mounted on that frame. The runners may be mounted to the frame and/or the car components. Most conveniently the runners provided in the lower part of the car can be mounted to the elevator car frame, while those in the upper part of the car can be mounted to a ceiling of the car assembly.

It will be understood that the invention also extends to a method of hoisting a car assembly within a hoistway comprising applying a hoisting force to the car assembly in such a position such as to create a turning moment on the car assembly and providing at least one runner on the car assembly for engagement with a wall of the hoistway so as to counteract the turning moment.

The invention also extends to a method of installing elevator equipment in a hoistway comprising using a car assembly in accordance with the invention as an installation platform, and also to a method of lifting elevator equipment in a hoistway using a car assembly in accordance with the invention.

A preferred embodiment of the invention will now be described by way of example only with reference to the accompanying drawings, in which like references depict like features and in which:

FIGS. 1A and 1B illustrate schematically a cantilever elevator system;

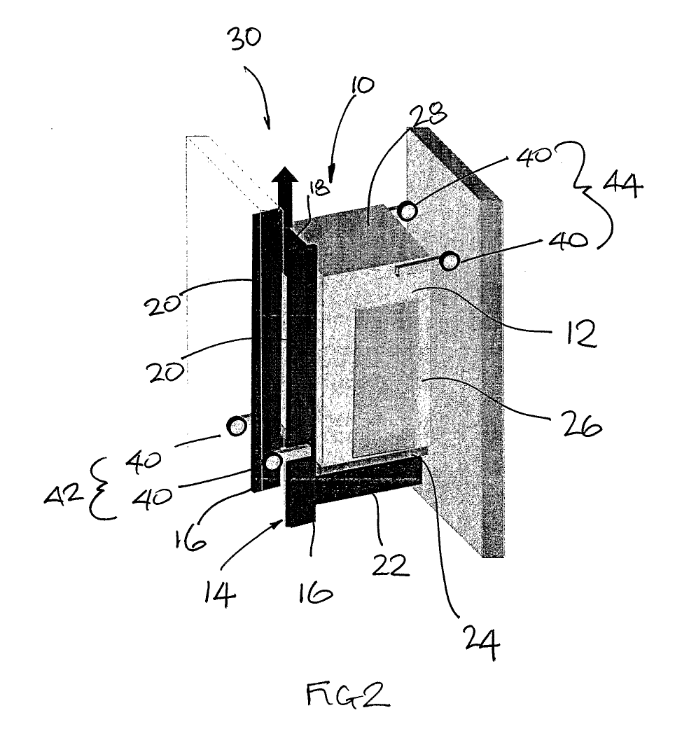

FIG. 2 shows, schematically, a car assembly in accordance with the invention;

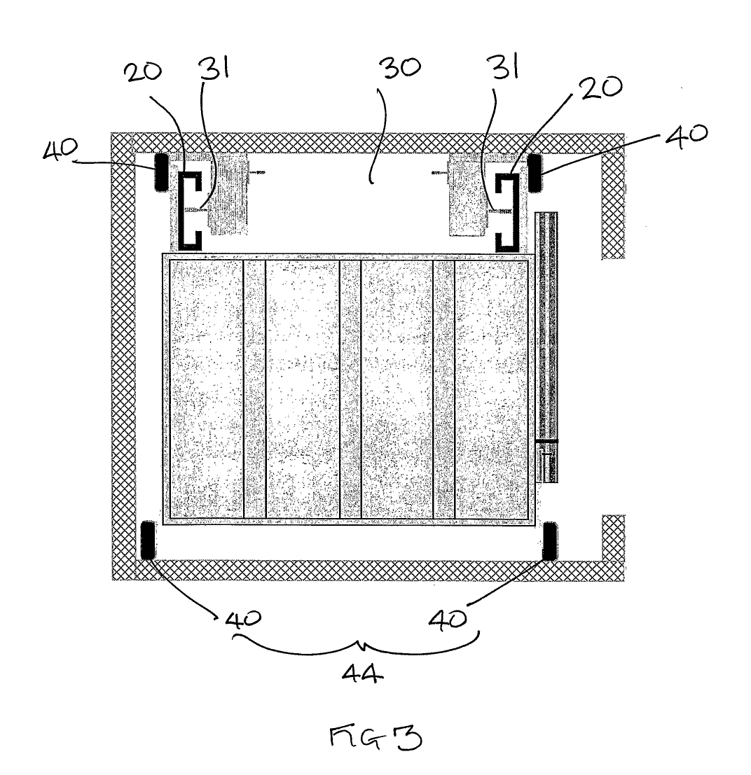

FIG. 3 illustrates schematically the car assembly of FIG. 2 within a hoistway;

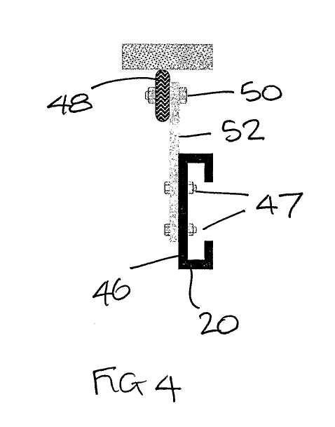

FIG. 4 shows, schematically, a wheel assembly mounted to the car assembly;

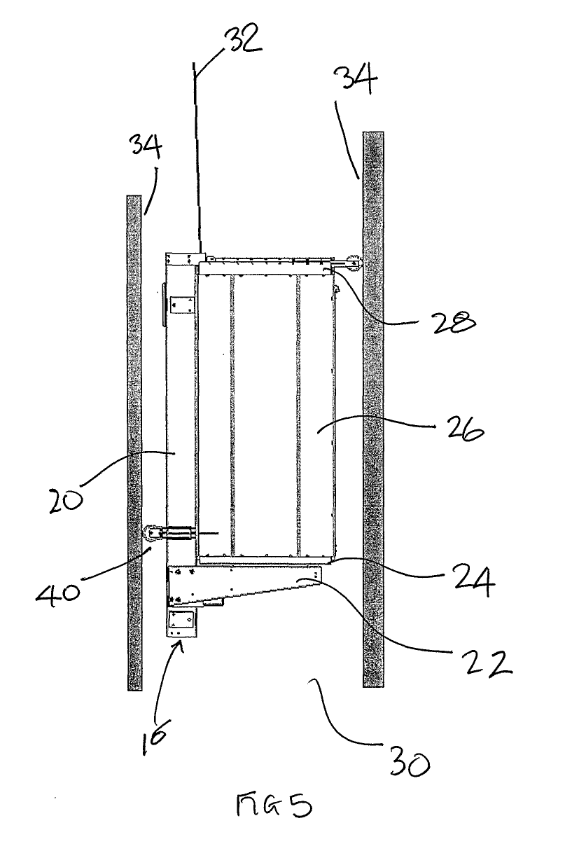

FIG. 5 shows inside elevation an elevator car assembly in accordance with the invention in situ within a hoistway;

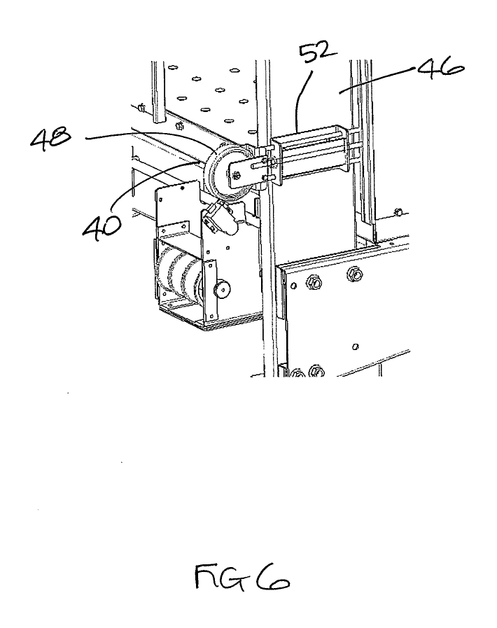

FIG. 6 shows in detail a wheel mounted on a car assembly;

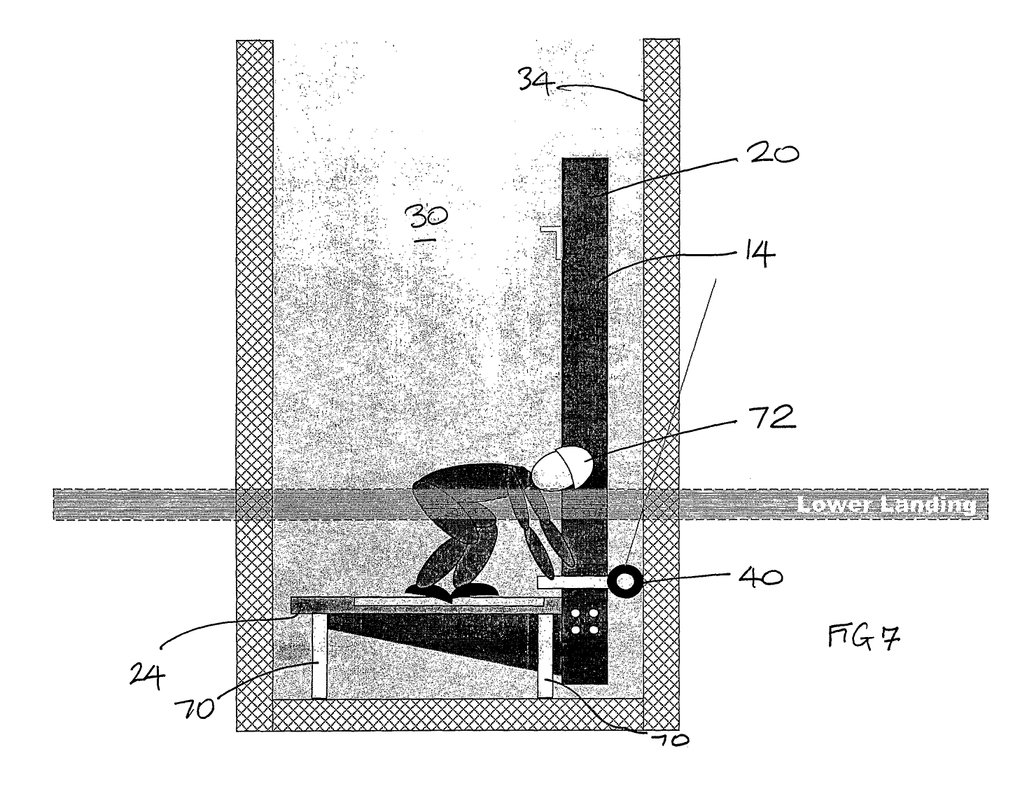

FIG. 7 shows, schematically, the installation of the lower wheels on a car frame;

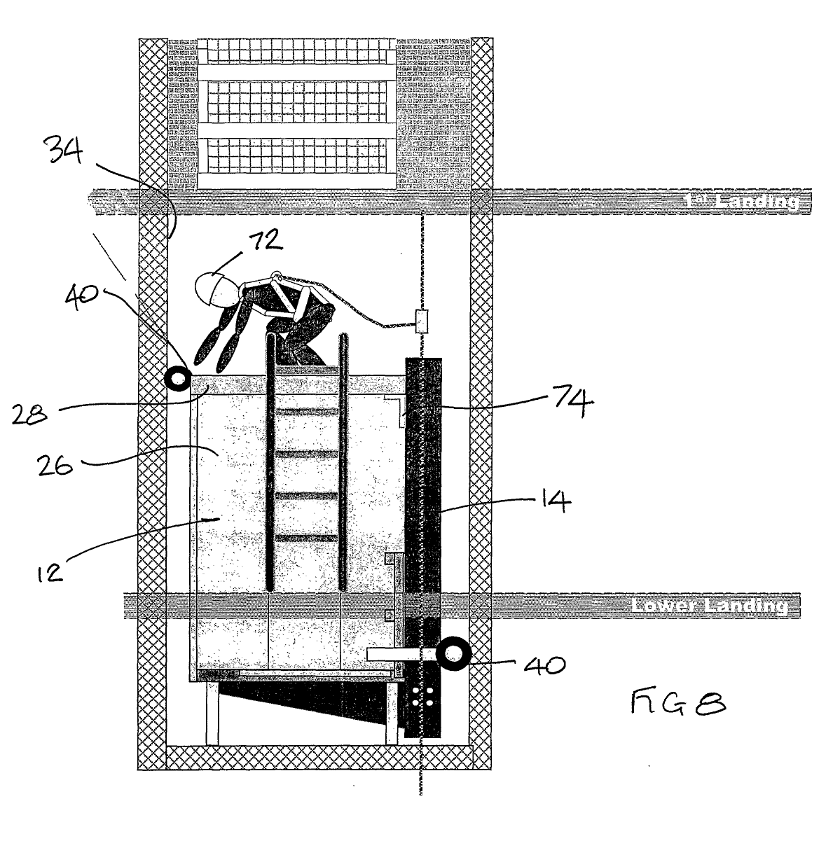

FIG. 8 illustrates installation of the upper wheels on the car assembly;

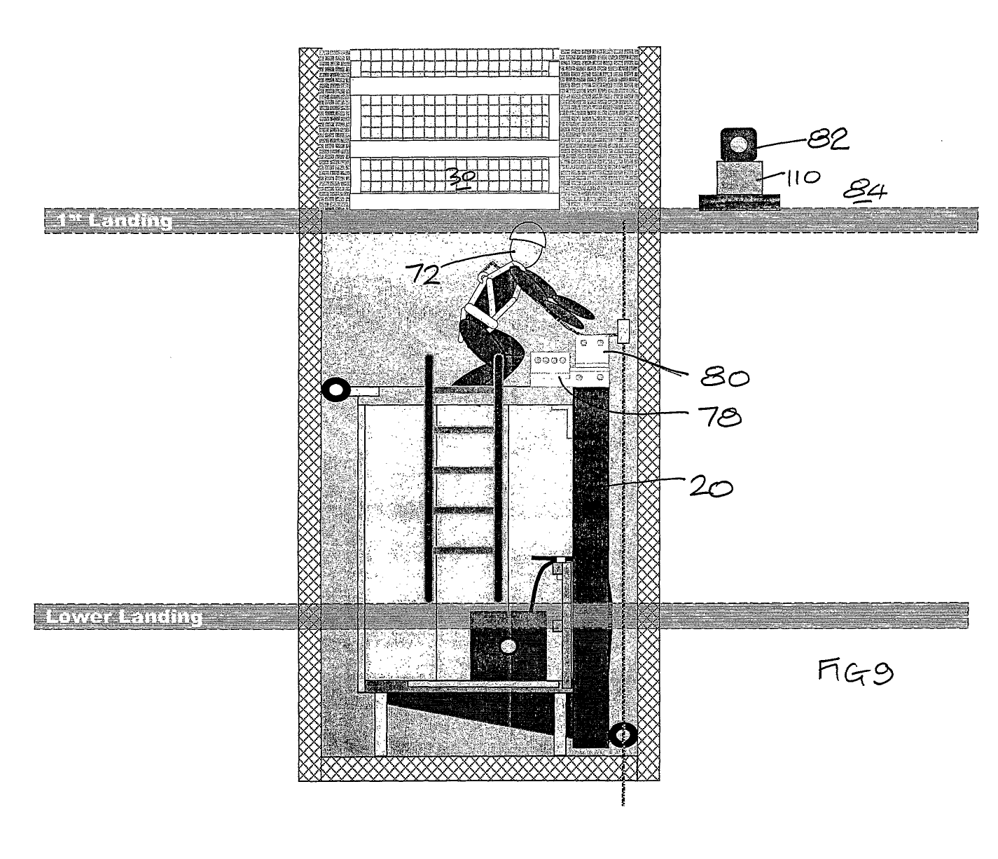

FIG. 9 shows the mounting of brackets on the car assembly;

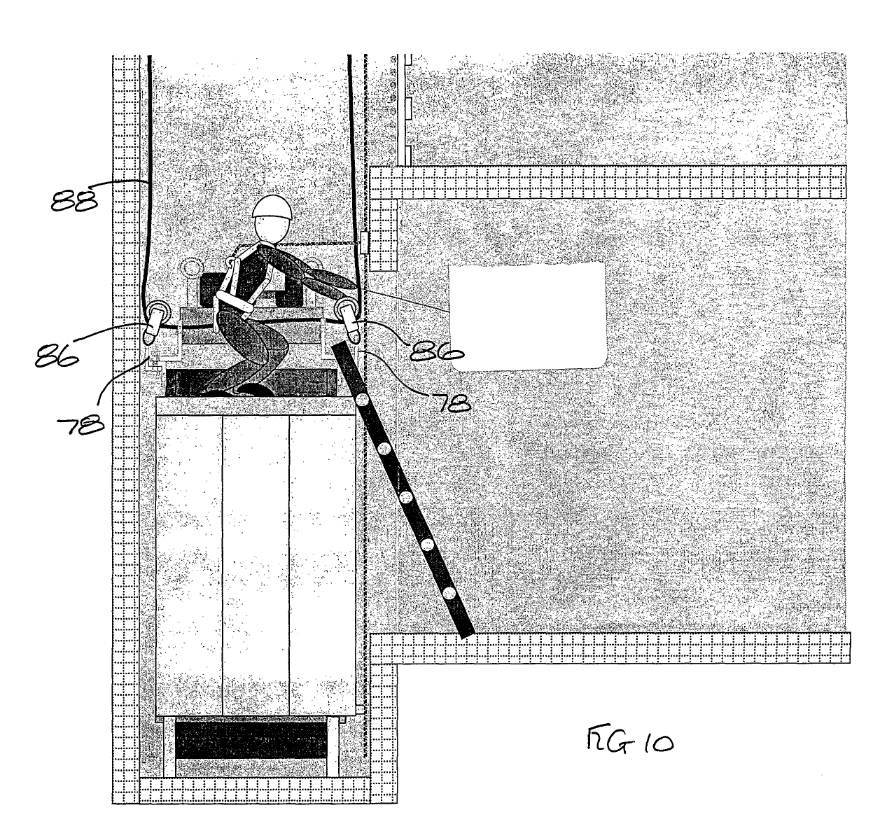

FIG. 10 shows the car assembly being readied for hoisting in the hoistway;

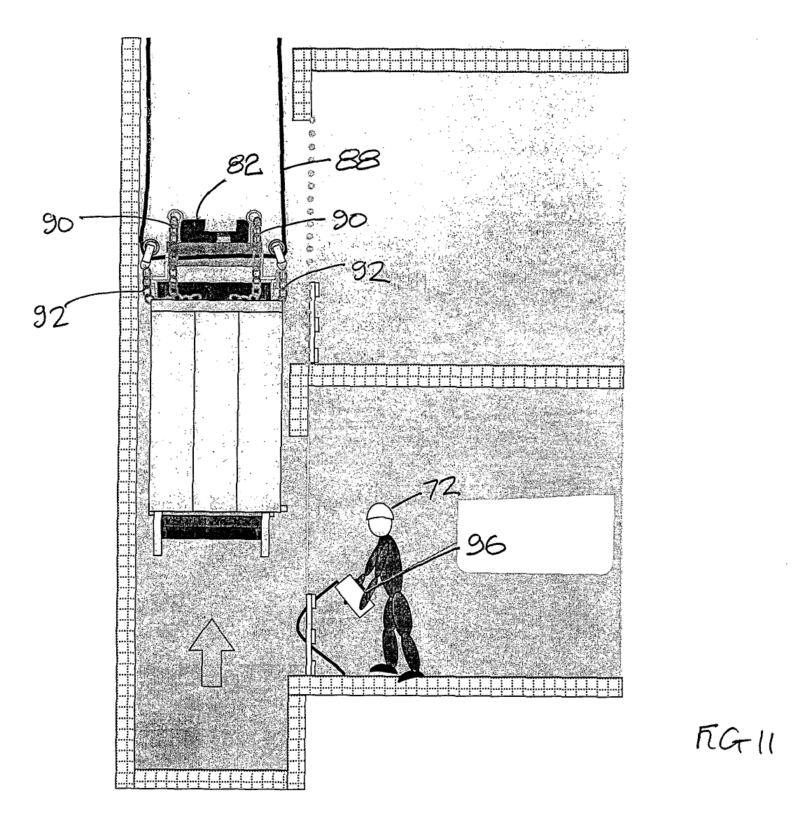

FIG. 11 shows the car assembly being hoisted in the hoistway;

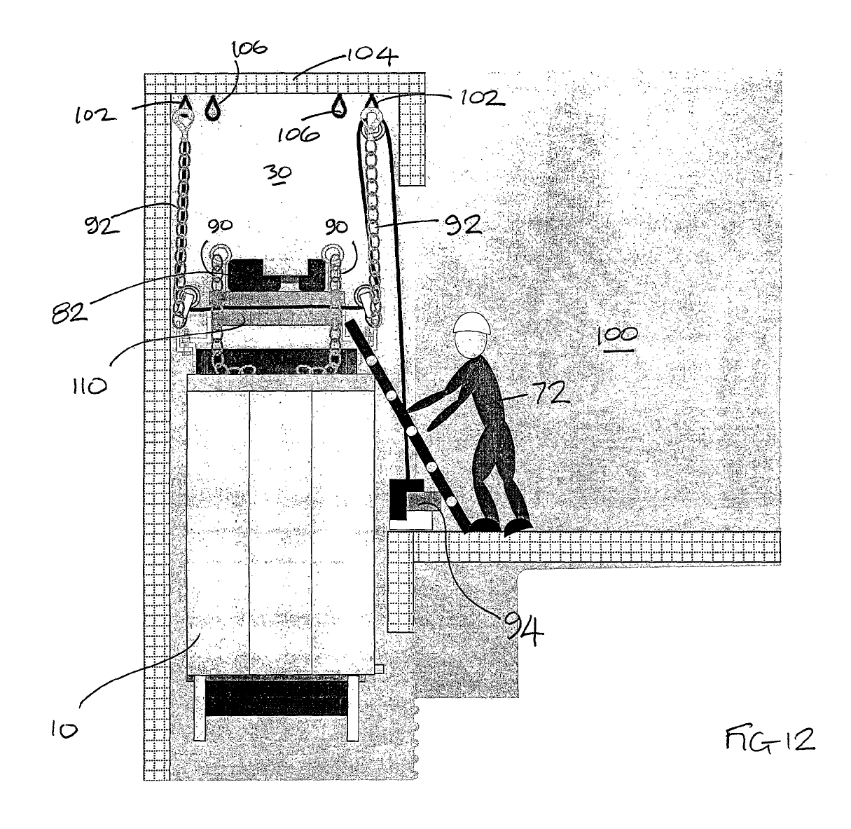

FIG. 12 shows the car assembly in position at the top of the hoistway;

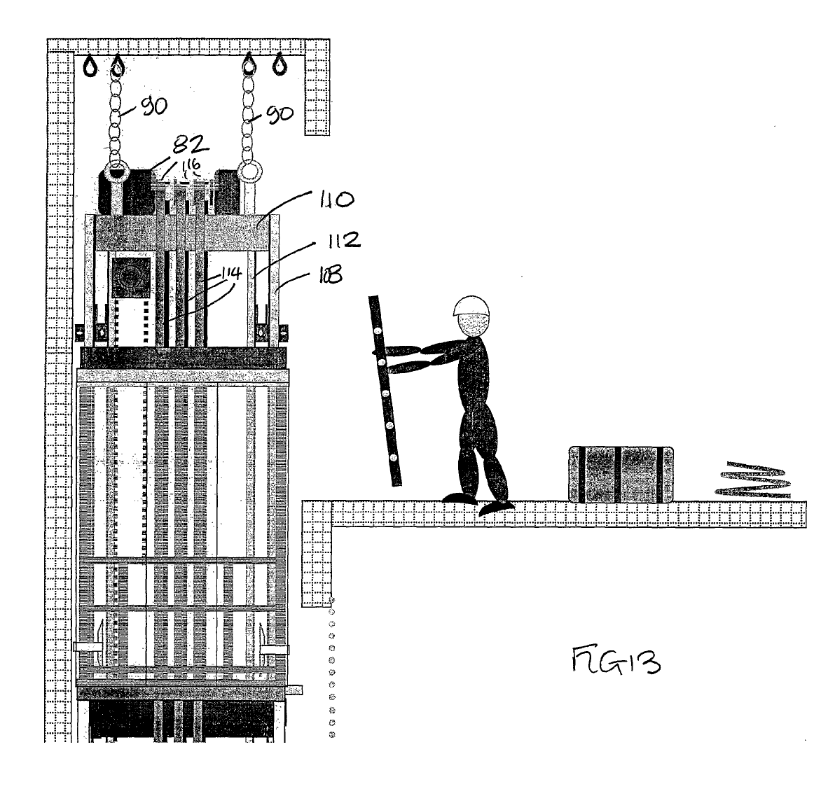

FIG. 13 shows the car assembly in a position for installing hoistway equipment;

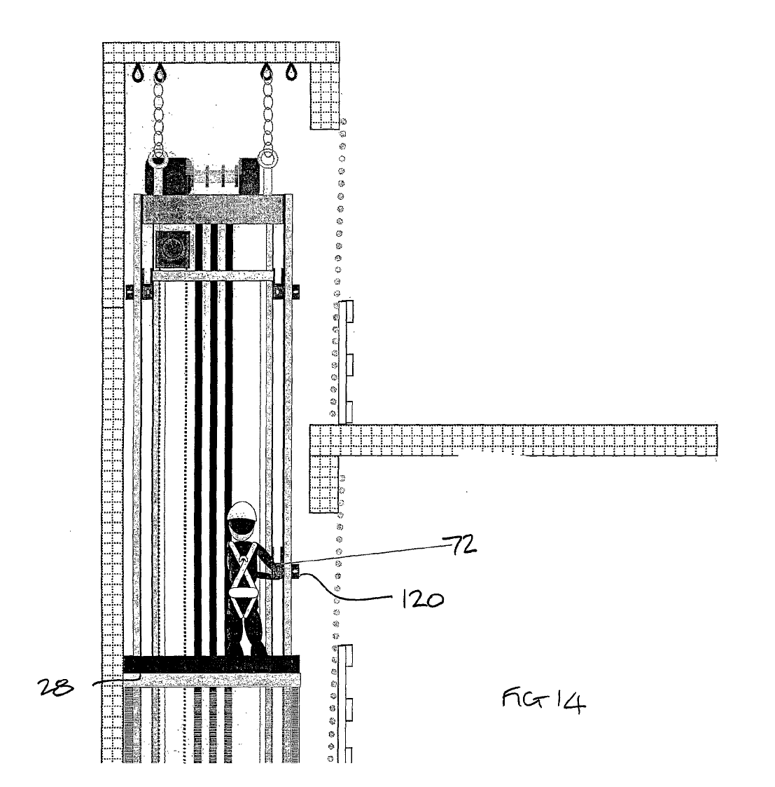

FIG. 14 shows the installation of guide rail wall brackets using the car assembly; and

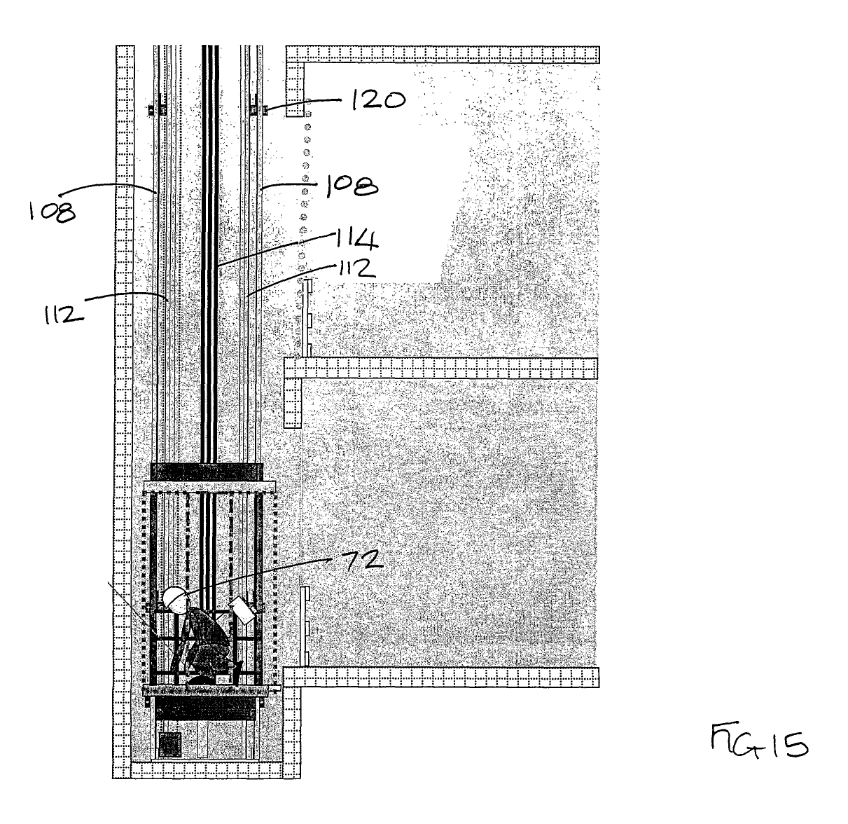

FIG. 15 shows removal of the wheel from the car assembly.

Referring firstly to FIG. 2, an elevator car assembly 10 in accordance with the invention comprises a car body 12 and a car frame 14 which supports the car body 12. The car frame 14 is generally L-shaped having two L-shaped side members 16 connected by cross members 18. Each L-shaped member 16 comprises a channel-sectioned vertical member 20 and a horizontal member 22 suitably attached to the vertical member 20.

The car body 12 comprises a floor 24 mounted on the horizontal frame member 22, wall panels 26 and a ceiling panel 28.

The car assembly 10 is shown located in a hoistway 30. When the elevator system is fully installed, the vertical frame members 20 will mount the car assembly to elevator guide rails 31 (FIG. 3) by rollers (not shown) provided within the frame members in a cantilever manner.

In order to raise the car assembly 10 in the hoistway 30 during installation of the elevator system, a hoisting rope 32 illustrated schematically in FIG. 5 is attached to the upper part of the car frame 14 so as to prevent hoisting forces being applied directly to the car body 12. The hoisting rope 32 suspends the car assembly and as illustrated in FIGS. 1A and 1B, due to the offset between the suspension points and the centre of gravity of the car assembly, a turning moment M is generated. If not countered, this moment would cause the car assembly 10 to rotate into contact with the hoistway walls 34.

In order to counter this moment, the car assembly 10 is provided with a plurality of wheels 40 which project from the car assembly 10 and engage the hoistway walls 34. The wheels 40 are arranged in a lower pair 42 and an upper pair 44.

The wheels 40 of the lower pair 42 are mounted to the outer face 46 of the vertical car frame member 20. As shown in more detail in FIGS. 4 and 6, each wheel 40 is mounted on a shaft 50 supported by a plate 52 which is fixed, e.g. bolted to the vertical frame member 20 by fasteners such as bolts 47.

The wheels 40 of the upper pair 44 are attached to the structural ceiling 28 of the elevator car in order to provide a firm support and have a similar construction to those of the lower pair 42.

Each wheel has a resilient, e.g. rubber, tyre 48 for engaging the hoistway walls 34 to better follow any discontinuities in the hoistway wall and minimise vibration and noise.

As can best be seen in FIG. 3, the wheels 40 of the respective upper and lower pairs 44, 42 are spaced apart laterally of the car assembly 10 so as substantially to prevent the car assembly 10 from rotating about a vertical axis during hoisting. Thus in the embodiment shown, the car assembly is substantially prevented from rotating about both horizontal and vertical axes during hoisting.

As discussed in the introduction above, the advantage of the present invention is that it allows the car assembly to be used as an installation platform when installing elevator equipment within the hoistway 30. FIGS. 7-13 illustrate this schematically.

FIG. 7 shows a car frame 14 mounting a car floor 24 arranged at the bottom of a hoistway 30. The car frame 14 is supported by props 70. With the car assembly in this position, an operative 72 installs the lower pair of wheels 42 to the vertical car frame members 20 as shown. The wheels 40 are arranged to engage the hoistway wall 34

The operative 72 then builds the car body 12 onto the car frame 14 and car floor 24. More specifically, sidewall panels 26 are built up and suitably fastened to the floor 24 and frame 14, and the car ceiling 28 positioned on top of the sidewalls 26 and affixed to the frame 14 by a structural bracket 74. This construction is sufficiently robust for the operative 72 to be able to stand on the car ceiling 28 and install the upper pair 44 of wheels onto the car ceiling 28, as shown in FIG. 8. Again, the upper wheels 44 are arranged to contact the hoistway wall 34.

Once the upper pair of wheels 44 is installed on the car assembly 12, the car assembly can be hoisted through the hoistway 30. In order to effect the hoisting, the operative 72 fits a lifting bracket 78 and a machine support bracket 80 to the respective frame members 20, as shown in FIG. 9.

The elevator machine 82 and its support 110 is then lifted into the hoistway 30 from an adjacent landing 84 and is mounted to the machine support bracket 80 for lifting within the hoistway 30.

Lifting pulleys 86 are then attached to the lifting brackets 78 as shown in FIG. 10 to receive a hoisting wire 88 for suspending the car assembly in the hoistway. Finally, support chains 90, 92 for the machine 82 and for the car assembly 10 respectively are also mounted to the assembly.

The operative 72 can then lift the car assembly 10 and elevator machine 82 through the hoistway 30 using a hoist 94 controlled by a control unit 96 until the car assembly 10 arrives at the top landing 100 of the hoistway 30, as shown in FIG. 12. The engagement of the wheels 40 with the hoistway walls 34 prevents the car assembly 10 from rotating about either vertical or horizontal axes as it moves up the hoistway 30.

At the top landing 100, the operative 72 attaches the car assembly support chains 92 to hooks 102 in the ceiling 104 of the hoistway 30. The machine support chains 90 are then also attached to hooks 106 in the hoistway ceiling 104. Once this has been done, car guide rails 108 can be introduced into the hoistway 30 and attached to the motor support 110. In smaller hoistways, only one pair of hooks 102, 106 need be provided, with the car assembly support chains 92 and the machine support chains 90 being attached to the same hooks.

Counterweight guide rails 112 and a counterweight (not shown) are also introduced into the hoistway. This allows drive belts 114 for the elevator to be installed, as shown in FIG. 13. The preferred roping arrangement is a 2:1 roping arrangement with the respective ends of the drive belts 114 being fixed in the top of the hoistway, for example to the machine support 110, and passing around idler sheaves provided on the counterweight and car frame 14 respectively and around drive sheaves 116 of the machine 82. It will be appreciated that in other installations other roping arrangements may be appropriate.

When this is done, the car assembly 10 may be moved up and down within the hoistway by means of the machine 82 which is, at this point, still supported on its chains 90. In effect the machine 82 is used as a hoist. As shown in FIG. 14, this can be effected by the operative 72 who is able to stand on the ceiling panel 28 of the elevator car. At this point the wheels 40 are still attached to the car assembly 10 so that the movement of the car assembly 10 within the hoistway is stabilised. This is necessary since the drive belts 114 are affixed to the car assembly 10 offset from the latter's centre of gravity, such that a turning moment is still generated by the weight of the car assembly 10.

As the car assembly 10 is moved down the hoistway 30, the operative is able to install system components such as guide rail support brackets 120 on the hoistway wall 34.

When all necessary work has been completed in the hoistway 30, and the car assembly has come to the base of the hoistway once more, the operative 72 can then remove the wheels 40, as shown in FIG. 15. The movement of the car thereafter is stabilised by the normal engagement of the car assembly 10 and the car guide rails 31. Up to that point, the wheels 40 prevent the car assembly 10 from tilting within the hoistway, thereby avoiding the need for the car frame to fully engage the guide rails 31.

It will be understood that the above description is of a preferred embodiment of the invention and that modifications may be made to the arrangement described without departing form the scope of the invention. For example, the invention is applicable to all cantilever type elevators, not just the specific example described above.

1-22. (canceled)

23. A cantilever elevator system comprising an elevator car assembly suspended within a hoistway such that a turning moment is generated on the car assembly, said elevator car assembly comprising at least one runner for engaging a hoistway wall so as to counter the turning moment.

24. A cantilever elevator system as claimed in claim 23, wherein the at least one runner is provided on one side of the elevator car assembly.

25. A cantilever elevator system as claimed in claim 24, wherein the at least one runner is provided at a lower part of the elevator car assembly on the same side of the elevator car assembly as at least one point of suspension of the car assembly.

26. A cantilever elevator system as claimed in claim 25, comprising at least one further runner provided at an upper, opposite part of the car assembly for engagement with an opposite hoistway wall.

27. A cantilever elevator system as claimed in claim 24, wherein the at least one runner is provided at an upper part of the elevator car assembly on the opposite side of the elevator car assembly to at least one point of suspension of the car assembly.

28. A cantilever elevator system as claimed in claim 23, wherein the at least one runner comprises a sliding element.

29. A cantilever elevator system as claimed in claim 23, wherein the at least one runner comprises a rolling element.

30. A cantilever elevator system as claimed in claim 29, wherein the rolling element is a roller.

31. A cantilever elevator system as claimed in claim 29, wherein rolling element is a wheel.

32. A cantilever elevator system as claimed in claim 31, wherein the wheel is provided with a tire.

33. A cantilever elevator system as claimed in claim 29, wherein the roller element comprises a resilient surface.

34. A cantilever elevator system as claimed in claim 23, comprising a single runner provided in a desired location.

35. A cantilever elevator system as claimed in claim 23, comprising a plurality of runners provided in desired locations.

36. A cantilever elevator system as claimed in claim 35, wherein the runners are spaced apart across one or more sides of the car assembly.

37. A cantilever elevator system as claimed in claim 23, wherein the car assembly comprises a car frame and car components mounted on the car frame.

38. A cantilever elevator system as claimed in claim 37, wherein at least one runner is mounted to the frame.

39. A cantilever elevator system as claimed in claim 37, wherein one or more runners are mounted to the car components.

40. A cantilever elevator system as claimed in claim 39, wherein one or more runners are mounted to a ceiling of the car assembly.

41. A method of hoisting a car assembly within a hoistway during installation of an elevator system, the method comprising the steps of:
applying a hoisting force to the car assembly in such a position such as to create a turning moment on the car assembly; and
providing at least one runner on the car assembly for engagement with a wall of the hoistway so as to counteract the turning moment.

42. A method as claimed in claim 41, comprising installing car guide rails in the hoistway.

43. A method as claimed in claim 41, comprising installing drive belts for the elevator system.

44. A method as claimed in claim 41, comprising subsequently removing the at least one runner.

45. A method of installing elevator equipment in a hoistway, comprising:
using a car assembly as an installation platform, said car assembly comprising at least one runner for engaging a wall of a hoistway such that the car assembly may move within the hoistway with the runner in contact with the hoistway wall.

46. A method of lifting cantilever elevator equipment in a hoistway, comprising:
using a car assembly comprising at least one runner for engaging a wall of a hoistway with the runner in contact with the hoistway wall.
